(19) United States
(12) Patent Application Publication
(10) Pub. No.: US 2024/0303958 A1
(43) Pub. Date: Sep. 12, 2024

(54) INFORMATION PROCESSING DEVICE, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Junya IKEDA, Kanagawa (JP)

(73) Assignee: FUJIFILM Business Innovation Corp., Tokyo (JP)

(21) Appl. No.: 18/446,551

(22) Filed: Aug. 9, 2023

(30) Foreign Application Priority Data
Mar. 8, 2023 (JP) 2023-035309

(51) Int. Cl. G06V 10/44; G06F 3/14; G06V 10/74

(52) U.S. Cl. CPC G06V 10/44; G06F 3/14; G06V 10/761

(57) ABSTRACT

An information processing device includes a processor configured to: be capable of accessing a memory storing content information in which image features are each associated with a corresponding display element, the display element being displayed on a display unit when the image feature is detected from a movie displayed on the display unit; detect, from a target movie which is a target to be processed, image features in accordance with a predetermined rule; and, in response to a difference between the image features detected from the target movie and the image features included in the content information, modify the content information on the basis of the difference.

### CROSS-REFERENCE TO RELATED APPLICATIONS

This application is based on and claims priority under 35 USC 119 from Japanese Patent Application No. 2023-035309 filed Mar. 8, 2023.

### BACKGROUND

### (i) Technical Field

The present disclosure relates to an information processing device, a non-transitory computer readable medium, and an information processing method.

### (ii) Related Art

Japanese Unexamined Patent Application Publication No. 2021-163165 discloses an information processing device. Information is extracted from drawings of manual data of a product. Examples of the information include an object figure, indicating an object of the manual, pointing figures, such as arrows or leaders, and text. On the basis of the extracted information, the information processing device creates manual data and displays the manual data on mixed reality (MR) glasses. International Publication No. 2017/122274 discloses an image display apparatus which determines whether operations, which are actually performed by a user on a target object within a specific field, are in accordance with the procedure indicated by a manual, on the basis of images captured by cameras included in a head mounted display (HMD).

Assume the case in which content information, in which multiple image features are associated with corresponding display elements, is prepared and in which an image feature included in the content information is detected from a movie captured by a camera. In this case, an information processing device is configured to display the associated display element on a display unit.

Although it is just an example, content information, in which display elements representing processes that are to be performed on processing targets are associated with the image features of the processing targets, is prepared, and a user performs the processes while photographing the processing targets by using a camera. Thus, information about the processes that are to be performed on the processing targets may be displayed step by step on a display unit as a manual.

In such an information processing device described above, the content information may need to be modified. In this case, in the related art, a manager or the like of the content information needs to modify the content information directly and manually. In direct, manual modification of the content information, for example, a part, which is to be modified, needs to be determined from the content information, and the corresponding image feature or the corresponding display element then needs to be modified, causing a problem of time and effort.

### SUMMARY

Aspects of non-limiting embodiments of the present disclosure relate to reduction of time and effort in modification of content information, in which multiple image features are each associated with a corresponding display element which is to be displayed on a display unit when the image feature is detected from a movie displayed on the display unit, compared with direct, manual modification of the content information.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device comprising a processor configured to: be capable of accessing a memory storing content information in which a plurality of image features are each associated with a corresponding display element, the display element being displayed on a display unit when the image feature is detected from a movie displayed on the display unit; detect, from a target movie which is a target to be processed, a plurality of image features in accordance with a predetermined rule; and, in response to a difference between the plurality of image features detected from the target movie and the plurality of image features included in the content information, modify the content information on a basis of the difference.

### BRIEF DESCRIPTION OF THE DRAWINGS

Exemplary embodiment of the present disclosure will be described in detail based on the following figures, wherein:

FIG. 1 is a schematic diagram illustrating the configuration of an information processing device according to the present exemplary embodiment;

FIG. 2 is a conceptual diagram illustrating an example of content information;

FIG. 3 is a first diagram illustrating the state in which display elements are displayed on a movie;

FIG. 4 is a second diagram illustrating the state in which display elements are displayed on a movie;

FIG. 5 is a third diagram illustrating the state in which display elements are displayed on a movie;

FIG. 6 is a first diagram illustrating an example of frame images in which image features are detected in a target movie;

FIG. 7 is a diagram illustrating multiple circumscribed rectangles corresponding to multiple objects detected from a single frame image;

FIG. 8 is a diagram illustrating an exemplary screen for setting a display text;

FIG. 9 is a first conceptual diagram illustrating an example of modified content information;

FIG. 10 is a first diagram illustrating a display example of multiple still images, which are included in content information, and multiple frame images;

FIG. 11 is a second diagram illustrating an example of frame images in which image features are detected in a target movie;

FIG. 12 is a second conceptual diagram illustrating an example of modified content information;

FIG. 13 is a diagram illustrating an exemplary screen for confirming deletion of content;

FIG. 14 is a second diagram illustrating a display example of multiple still images, which are included in content information, and multiple frame images;

FIG. 15 is a third diagram illustrating an example of frame images in which image features are detected in a target movie;

FIG. 16 is a third conceptual diagram illustrating an example of modified content information;

FIG. 17 is a third diagram illustrating a display example of multiple still images, which are included in content information, and multiple frame images; and

FIG. 18 is a flowchart of a process of an information processing device according to the present exemplary embodiment.

### DETAILED DESCRIPTION

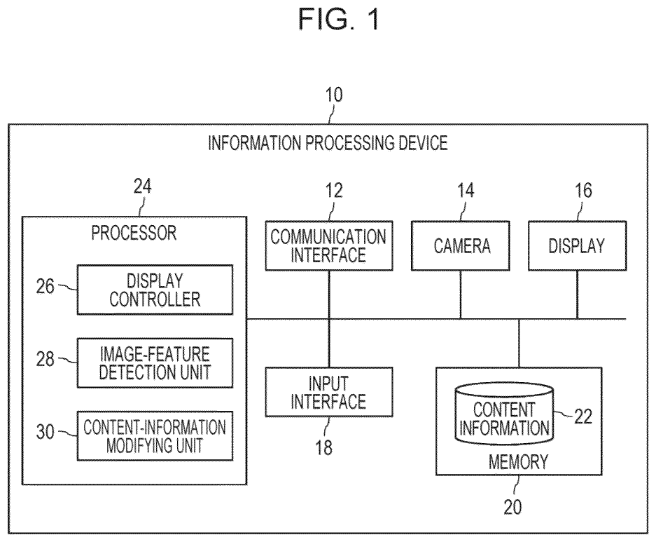

FIG. 1 is a schematic diagram illustrating the configuration of an information processing device 10 according to the present exemplary embodiment. The information processing device 10, which includes an imaging unit and a display unit, is capable of being carried by a user of the information processing device 10 or a modifier who modifies content information 22 described below. Examples of the information processing device 10 include a smartphone, a head-mounted display (HMD), and augmented reality (AR) glasses. However, another device may be used as long as the device is capable of fulfilling the functions described below.

As described below in detail, in the present exemplary embodiment, the information processing device 10 displays, on the display unit, a movie captured by the imaging unit, and, at the same time, displays, on the display unit, a display element based on an image feature detected from the movie. For example, a worker, who is a user doing a certain work, does the work while photographing work targets by using the information processing device 10. When a predetermined image feature is detected from the obtained movie, information (for example, a manual), which corresponds to the image feature and which describes the work, is displayed on the display unit.

A display element may be displayed on a movie captured by the imaging unit. That is, the information processing device 10 may cause a user to perceive a fusion of the real world and the virtual world by using a technique, such as AR, MR, or diminished reality (DR).

A communication interface 12 is formed, for example, of a network card. The communication interface 12 fulfills a function of communicating with other apparatuses such as a server.

A camera 14, which serves as an imaging unit, is formed, for example, of a lens and an imaging device such as a charge-coupled device (CCD). The camera 14 has a function of capturing a movie. Hereinafter, in the specification, a movie captured by the camera 14 may be referred to simply as a “movie”.

A display 16, which serves as a display unit, is formed, for example, of a liquid-crystal display or an organic light-emitting diode (OLED) display. On the display 16, various screens are displayed in accordance with instructions from a processor 24 (particularly, a display controller 26) described below.

An input interface 18 is formed, for example, of various buttons, a touch panel, or a microphone. The input interface 18 is used to input instructions from a user or a modifier of the content information 22 to the information processing device 10.

A memory 20 includes, for example, an embedded multi media card (eMMC), a read only memory (ROM), or a random access memory (RAM). The memory 20 is connected to the processor 24 so as to be capable of being accessed by the processor 24 described below. The memory 20 stores an information processing program for operating the units of the information processing device 10. The information processing program may be stored in a non-transitory computer readable storage medium, such as a Universal Serial Bus (USB) memory or a secure digital (SD) card. The information processing device 10 may read, for execution, the information processing program from such a storage medium. As illustrated in FIG. 1, the memory 20 stores the content information 22.

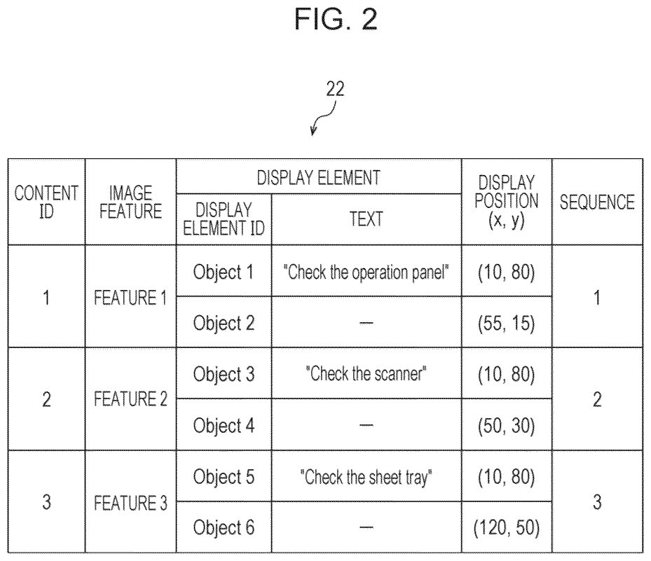

FIG. 2 is a conceptual diagram illustrating an example of the content information 22. In the content information 22, multiple image features are each associated with a corresponding display element which is to be displayed on the display 16 when the image feature is detected from a movie displayed on the display 16. In other words, the content information 22 stores multiple combinations of an image feature and a display element. In the present specification, information (a record in FIG. 2) including a combination of an image feature and a display element is called a “unit content”, and multiple unit contents are called “content information 22” collectively. As illustrated in FIG. 2, a unit content may include multiple display elements. In other words, an image feature may be associated with multiple display elements.

In the present exemplary embodiment, each unit content included in the content information 22 has a content ID for identifying the unit content uniquely, an image feature, a display element, a display position, and sequence information which are associated with each other.

An image feature is, for example, a parameter representing the shape, color, texture, or the like of an object detected from frame images included in a movie (in other words, still images included in the movie). An image feature may be expressed as a feature vector having multiple elements (in other words, multi-dimensional). By using an image feature, for example, whether a detected object is a display panel or a sheet tray may be also specified. A display element is an object that is to be displayed on the display 16. In the present exemplary embodiment, the content information 22 includes, as information indicating a display element, a display element ID for identifying the display element uniquely, and a text used when the display element is an object including a text. A display position is information indicating the position on the display 16 at which the display element is to be displayed. In the present exemplary embodiment, a display position is expressed as x, y coordinates on the display 16. Sequence information indicates a sequence number at which the image feature is to appear in a movie. Sequence information may be used when a user wants to confirm the previous work or the next work of their current work.

In the content information 22, multiple image features may be further associated with still images including the respective image features.

How to use the content information 22 and how to modify the content information 22 will be described below along with the details of the process of the processor 24.

The processor 24 is formed, for example, of a central processing unit (CPU). The processor 24 uses the information processing program, which is stored in the memory 20, to fulfill functions as the display controller 26, an image-feature detection unit 28, and a content-information modifying unit 30.

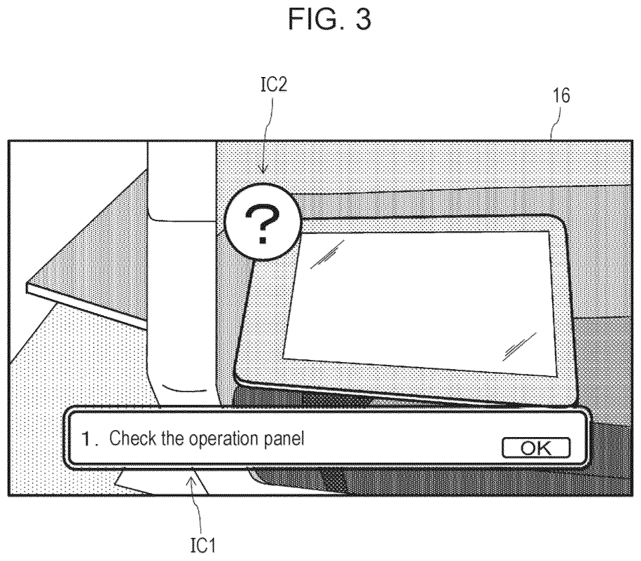

The display controller 26 exerts control for displaying various screens on the display 16. In the present exemplary embodiment, the display controller 26 displays, on the display 16, a movie captured by the camera 14. Further, in response to the image-feature detection unit 28, which is described below, extracting, from a movie, an image feature included in the content information 22, the display controller 26 displays, on the display 16, the display element associated with the image feature in the content information 22. The process will be described below in detail by referring to FIGS. 3 to 5 along with the details of the process of the image-feature detection unit 28.

The image-feature detection unit 28 detects an image feature from a movie captured by the camera 14. Specifically, the image-feature detection unit 28 detects an object from a movie, and then detects an image feature indicating the feature of the detected object. In detection of an object from a movie, a known method may be used. For example, the image-feature detection unit 28 may use a learning model such as a convolutional neural network (CNN) to detect an object from a movie. As described above, an image feature is a parameter representing the shape, color, texture, or the like of a detected object. In the present exemplary embodiment, the image-feature detection unit 28 detects an image feature in the form of a feature vector having multiple elements.

Referring to FIGS. 3 to 5, the process of detecting an image feature from a movie by the image-feature detection unit 28 and the subsequent process of displaying a display element by the display controller 26 will be described. In FIGS. 3 to 5, an example in which the content information 22 is a manual about operations of a multifunction device and in which display elements, which serve as the manual, are displayed in accordance with user operations on the multifunction device is illustrated.

A user operates the multifunction device while photographing the multifunction device by using the camera 14. First, the user photographs the operation panel of the multifunction device by using the camera 14. As illustrated in FIG. 3, the display controller 26 displays, on the display 16, the movie captured by the camera 14.

At the same time, the image-feature detection unit 28 detects image features from each frame image included in the movie. Every time the image-feature detection unit 28 detects an image feature, the display controller 26 refers to the content information 22 (see FIG. 2), and determines whether the detected image feature is included in the content information 22. When an image feature detected by the image-feature detection unit 28 is included in the content information 22, as illustrated in FIG. 3, the display controller 26 displays, on the display 16, the display elements associated with the image feature in the content information 22. The content information 22 is illustrated in FIG. 2, and “feature 1” is detected as an image feature from the frame image illustrated in FIG. 3. Thus, the display controller 26 displays, on the display 16, the display elements which are associated with “feature 1” in the content information 22 and which are a display element IC1 whose display element ID is “Object 1” and a display element IC2 whose display element ID is “Object 2”. The display controller 26 displays the display element IC1 at a position indicated by the display position associated with the display element ID, “Object 1”, in the content information 22, and displays the display element IC2 at a position indicated by the display position associated with the display element ID, “Object 2”, in the content information 22.

As the user operation on the multifunction device advances, the movie (specifically, the frame image) captured by the camera 14 changes. The display controller 26 continues to display the movie on the display 16. The image-feature detection unit 28 also continues to detect image features from each frame image. In response to the detection, the display controller 26 also continues to determine, for each detected image features, whether the detected image feature is included in the content information 22.

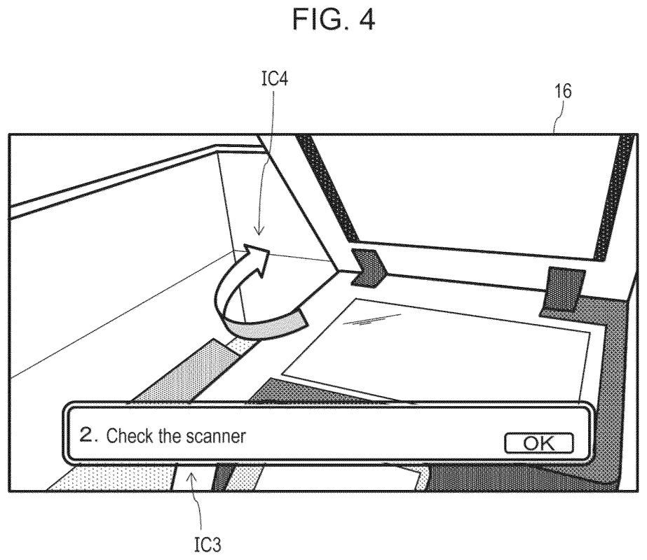

In the frame image illustrated in FIG. 4, when the image-feature detection unit 28 detects “feature 2” as an image feature, the display controller 26 displays, on the display 16, the display elements which are associated with “feature 2” in the content information 22 and which are a display element IC3 whose display element ID is “Object 3” and a display element IC4 whose display element ID is “Object 4”.

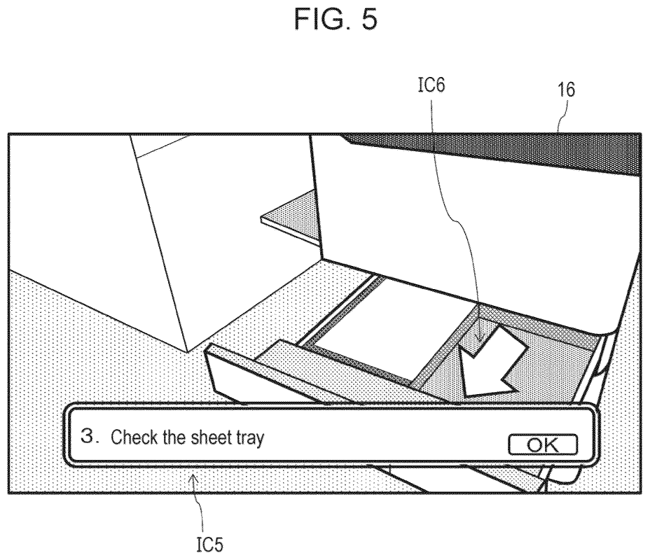

Similarly, in the frame image in FIG. 5, when the image-feature detection unit 28 detects “feature 3” as an image feature, the display controller 26 displays, on the display 16, the display elements which are associated with “feature 3” in the content information 22 and which are a display element IC5, whose display element ID is “Object 5” and a display element IC6 whose display element ID is “Object 6”.

As described above, in the present exemplary embodiment, a unit content has sequence information. Thus, the display controller 26 may display, on the display 16, the content based on the sequence information. For example, assume that the content information 22 has content as illustrated in FIG. 2 and that the image-feature detection unit 28 detects an image feature of “feature 1” from a movie. In this case, the image feature of “feature 1” is associated with sequence information of “1”. Thus, the image feature which is to be detected next is “feature 2” associated with sequence information of “2”. In other words, a user is to operate the object, which is represented by the image feature of “feature 2”, next. Therefore, when the image-feature detection unit 28 detects an image feature of “feature 1” from a movie, either in accordance with a user instruction or automatically, the display controller 26 may display, on the display 16, information (for example, the text included in a display element associated with sequence information of “2”) about an object, which the user is to operate next, prior to the image-feature detection unit 28 detecting an image feature “feature 2”.

In another example, assume that, after the image-feature detection unit 28 detects an image feature of “feature 1”, the image-feature detection unit 28 detects an image feature of “feature 3” before detection of an image feature of “feature 2”. This detection sequence is not the sequence indicated by the sequence information associated with the image features of “feature 1” to “feature 3”. Accordingly, in this case, the display controller 26 may notify the user of this.

Back to FIG. 1, the content-information modifying unit 30 modifies the content information 22. As described below in detail, the information processing device 10 enables a modifier of the content information 22 to modify the content information 22 without necessity of direct, manual modification. The modifier of the content information 22 may be a manager or a user of the information processing device 10. An example of the case in which the content information 22 is to be modified is the case in which the method of operating the device is changed when the content information 22 is a manual about operations of the device. However, the example is not limited to this.

A modifier of the content information 22 captures a movie by using the camera 14 according to the newly defined procedure. In the present specification, a movie which is a target to be processed for modification of the content information 22 is called a “target movie”.

The image-feature detection unit 28 detects image features from the target movie in accordance with a predetermined rule.

For example, the image-feature detection unit 28 detects, from the movie, the image feature of an object photographed continuously for a predetermined time or longer. Thus, an object, which is photographed by chance only for a short time on the background of the target movie, or an object, which is photographed by chance in the target movie while the target to be photographed by using the camera 14 is changed to another target (for example, while the orientation of the lens of the camera 14 is changed), may be excluded from targets from which image features are to be extracted.

A known technique may be used to determine whether the same object is photographed continuously for a predetermined time or longer. For example, the image-feature detection unit 28 verifies the sameness of objects detected from a certain frame image and the next frame image in a target movie on the basis of the similarity between the feature vector, which represents an image feature, such as the shape, position, color, or the like of the object detected from the certain frame image, and the feature vector, which represents the image feature of the object detected from the next frame image. For example, if the cosine similarity between the feature vectors is less than or equal to a threshold, it may be determined that the feature vectors (that is, the objects) are the same. The image-feature detection unit 28 adds the same label (in other words, the same identifier) to the objects determined to be the same. When objects, to which the same label is added, are continuously detected from a predetermined number or more of frame images (that is, for the predetermined time or longer), the image-feature detection unit 28 determines that the same object is continuously photographed for the predetermined time or longer.

When multiple objects are detected from a single frame image included in a target movie and when the image feature of one of the objects is stored in the content information 22, the image-feature detection unit 28 detects only the image feature of the object and does not detect the image features of the other objects.

Through the process described above, one or more image features are detected from a target movie. The image-feature detection unit 28 may detect, in real time, image features from a target movie captured by the camera 14. Alternatively, the image-feature detection unit 28 may detect image features from a target movie after the camera 14 finishes capturing the target movie.

The content-information modifying unit 30 compares the image features, which are detected from a target movie, with the image features, which are included in the content information 22. When the determination result indicates that there is a difference between the image features detected from the target movie and the image features included in the content information 22, the content-information modifying unit 30 modifies the content information 22 on the basis of the difference.

The types of modification of the content information 22 are addition of a unit content, deletion of a unit content, and modification of the sequence information of unit contents. Each case will be described below. In the description below, assume that the content information 22 before modification is illustrated in FIG. 2.

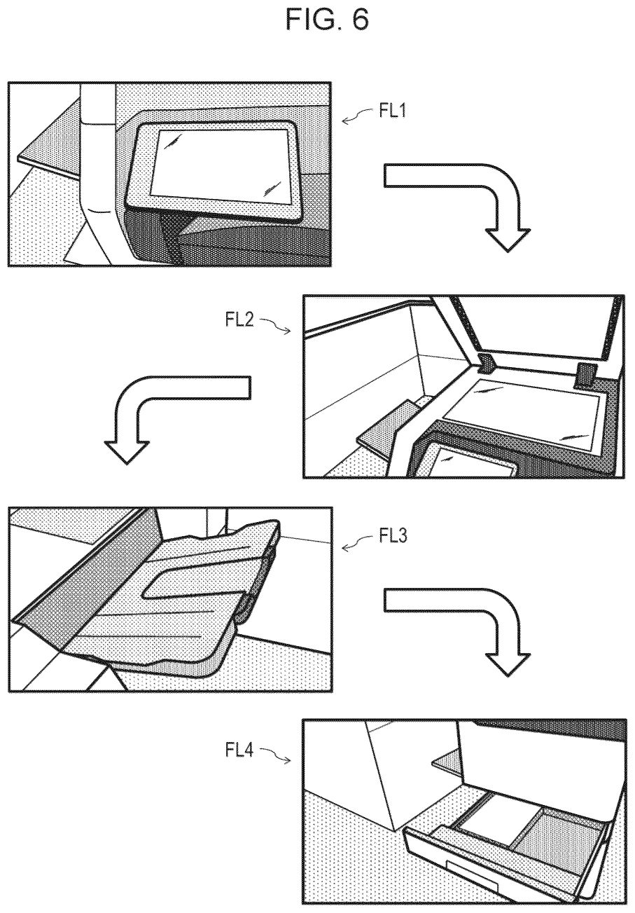

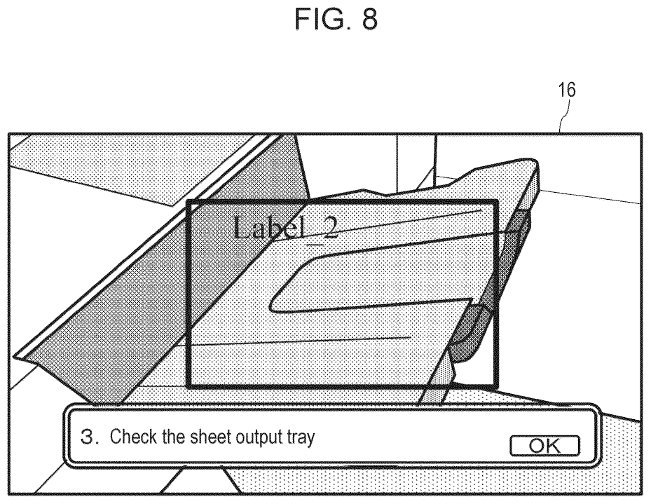

Referring to FIGS. 6 to 10, addition of a unit content will be described. FIG. 6 is a diagram illustrating frame images FL1 to FL4 in which image features are detected in a target movie. The frame images FL1 to FL4 are arranged chronologically. That is, in the target movie, the frame image FL2 appears after the frame image FL1; the frame image FL3 appears after the frame image FL2; the frame image FL4 appears after the frame image FL3.

In the example in FIG. 6, assume that an image feature of “feature 1” is detected from the frame image FL1 in the target movie; an image feature of “feature 2” is detected from the frame image FL2 in the target movie; an image feature of “feature 4” is detected from the frame image FL3 in the target movie; an image feature of “feature 3” is detected from the frame image FL4 in the target movie.

The content-information modifying unit 30 compares the image features, which are detected from the target movie, with the image features, which are included in the content information 22. As described above, in the example in FIG. 6, the image features detected from the target movie are “feature 1”, “feature 2”, “feature 4”, and “feature 3”. In contrast, the image features included in the content information 22 are “feature 1”, “feature 2”, and “feature 3”. Therefore, an image feature of “feature 4” is included in the image features detected from the target movie, while an image feature of “feature 4” is not included in the image features included in the content information 22. In other words, the image-feature detection unit 28 detects, from the target movie, a new image feature (in this example, an image feature of “feature 4”) which is not included in the content information 22. In this case, the content-information modifying unit 30 determines that there is a difference between the image features detected from the target movie and the image features included in the content information 22.

The specification uses simple expressions such as “feature 1”. However, it is considered that there are only a few cases in which an image feature detected from a target movie completely matches an image feature included in the content information 22. Therefore, the content-information modifying unit 30 may regard, as the case of the same image feature, the case in which the similarity (for example, the cosine similarity) between an image feature detected from the target movie and any image feature included in the content information 22 is less than or equal to a predetermined threshold.

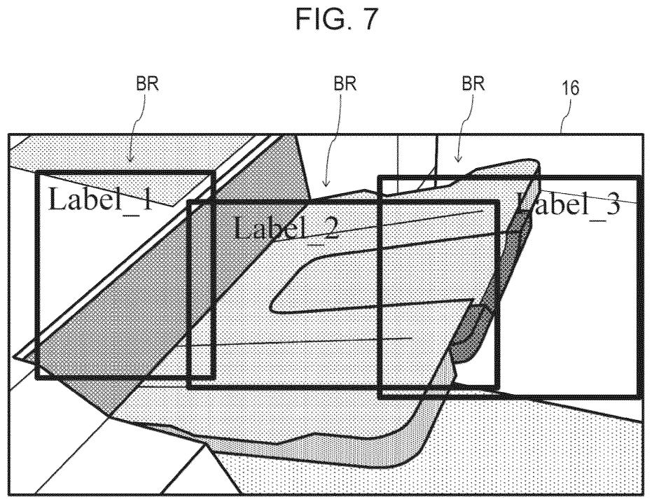

When the image-feature detection unit 28 detects a new image feature, as illustrated in FIG. 7, the display controller 26 displays, on the display 16, the frame image (in this example, the frame image FL3), in which a new image feature is detected. As described above, the image-feature detection unit 28 has detected objects from the frame image before detection of the new image feature. As illustrated in FIG. 7, in the present exemplary embodiment, the display controller 26 displays, on the frame image, circumscribed rectangles BR of one or more objects detected from the frame image in which the new image feature is detected. In the example in FIG. 7, the three circumscribed rectangles BR labeled with “Label_1”, “Label_2”, and “Label_3” are displayed. That is, three new image features related to three objects corresponding to the respective three circumscribed rectangles BR have been detected from the frame image.

A modifier of the content information 22 (hereinafter simply referred to as a “modifier”) may select a circumscribed rectangle BR from the displayed circumscribed rectangles BR. This corresponds to selection of a new image feature which is to be added to the content information 22. In this example, assume that the modifier selects a circumscribed rectangle BR of “Label_2”. Thus, the content-information modifying unit 30 determines a new image feature which is to be added to the content information 22, on the basis of the instruction from the modifier.

Then, the content-information modifying unit 30 determines a new display element which is associated with the new image feature which has been determined. In the present exemplary embodiment, assume that the new display element is an object including a text. A new display element may be, for example, an icon which is prepared in advance.

The content-information modifying unit 30 may determines a new display element on the basis of an instruction from the modifier. In the present exemplary embodiment, the content-information modifying unit 30 determines the text of the new display element on the basis of an instruction from the modifier. The modifier inputs the text of the new display element through the input interface 18. For example, a text may be input by using a touch panel or buttons, or may be input through voice from a microphone. The content-information modifying unit 30 assigns a new content ID, and adds, to the content information 22, a unit content in which the content ID, the new image feature, the display element ID of the new display element, and the text which is input by the modifier are associated with each other.

The content-information modifying unit 30 may determine the display position of the new display element on the display 16, on the basis of an instruction from the modifier. The modifier inputs the display position of the new display element through the input interface 18. The content-information modifying unit 30 may further associate the display position of the new display element with the unit content including the new image feature and the new display element, and may add the unit content to the content information 22.

The content-information modifying unit 30 may determine the sequence number at which the new image feature is to appear in a movie. The content-information modifying unit 30 may determine the sequence number of the new image feature on the basis of the order of appearance of the image features detected from the target movie. In this example, the image features are detected from the target movie in the sequence of “feature 1”, “feature 2”, “feature 4”, and “feature 3”. Thus, the sequence number of the new image feature of “feature 4” is “3”. The content-information modifying unit 30 may further associate the sequence information with the unit content including the new image feature and the new display element, and may add the unit content to the content information 22. In response to this, the content-information modifying unit 30 may modify the sequence information associated with the image feature of “feature 3” (in this example, from “3” to “4”).

The content-information modifying unit 30 may further associate the frame image (in this example, the frame image FL3), in which the new image feature is detected, as a still image with the unit content including the new image feature and the new display element, and may add the unit content to the content information 22.

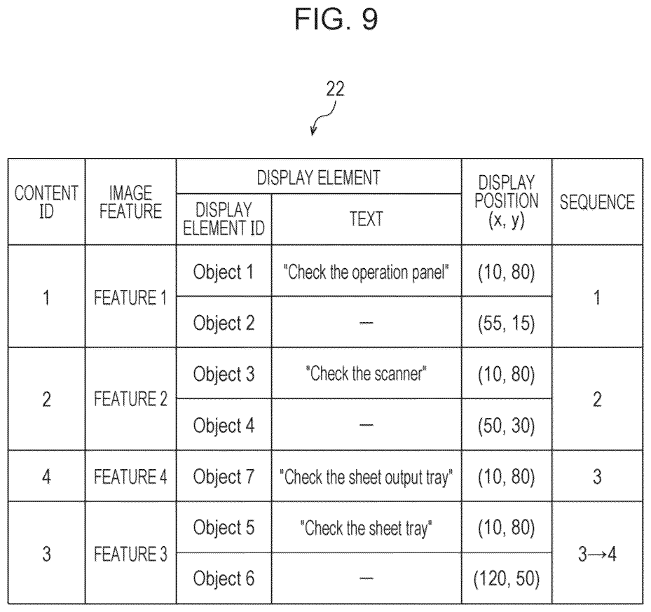

FIG. 9 illustrates an example of the modified content information 22.

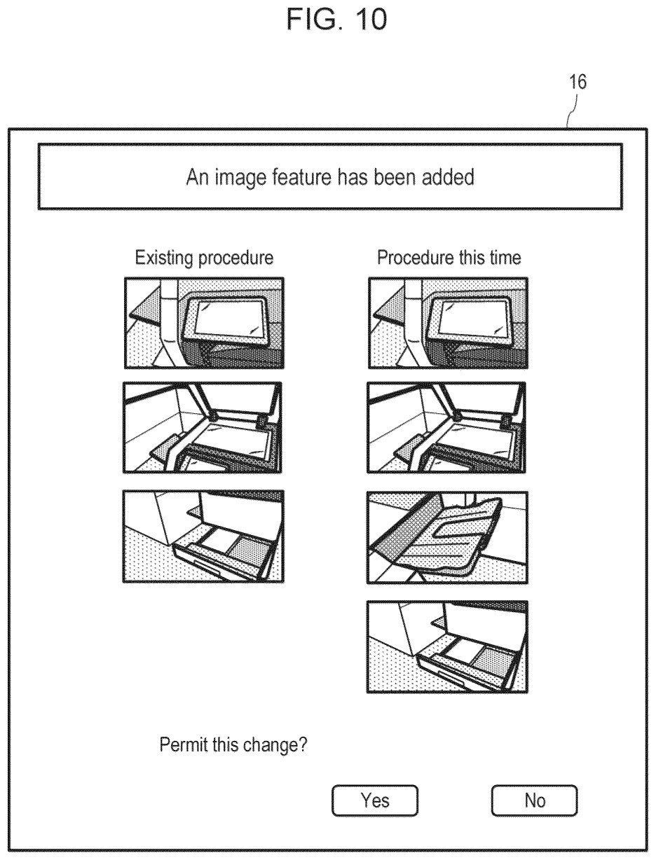

When, in the content information 22, each image feature is associated with a still image including the image feature, as illustrated in FIG. 10, the display controller 26 may display, on the display 16, the still images, which correspond to the image features included in the content information 22, and frame images, in which image features are detected from a target movie, prior to the content-information modifying unit 30 modifying the content information 22. When the modifier approves (for example, presses the “Yes” button) on the screen, the content-information modifying unit 30 adds the unit content for the new image feature.

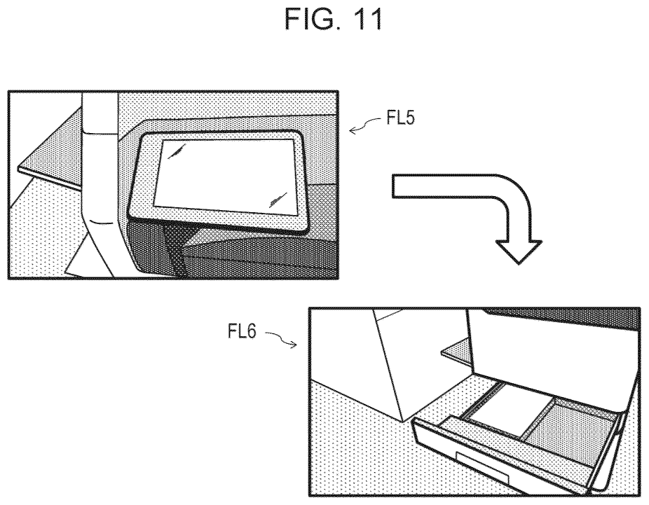

Referring to FIGS. 11 to 14, deletion of a unit content will be described. FIG. 11 is a diagram illustrating frame images FL5 and FL6 in which image features are detected in a target movie. The frame images FL5 and FL6 are arranged chronologically. That is, in the target movie, the frame image FL6 appears after the frame image FL5.

In the example in FIG. 11, assume that an image feature of “feature 1” is detected from the frame image FL5 in the target movie; an image feature of “feature 3” is detected from the frame image FL6 in the target movie.

The content-information modifying unit 30 compares the image features, which are detected from the target movie, with the image features, which are included in the content information 22. As described above, in the example in FIG. 11, the image features detected from the target movie are “feature 1” and “feature 3”. In contrast, the image features included in the content information 22 are “feature 1”, “feature 2”, and “feature 3”. That is, there is a deleted image feature (in this example, an image feature of “feature 2”) which is included in the content information 22 and which is not detected from the target movie. In this case, the content-information modifying unit 30 determines that there is a difference between the image features detected from the target movie and the image features included in the content information 22.

When there is a deleted image feature, the content-information modifying unit 30 deletes the unit content for the deleted image feature from the content information 22. In response to this, the content-information modifying unit 30 may modify the sequence information associated with the image feature of “feature 3” (in this example, from “3” to “2”).

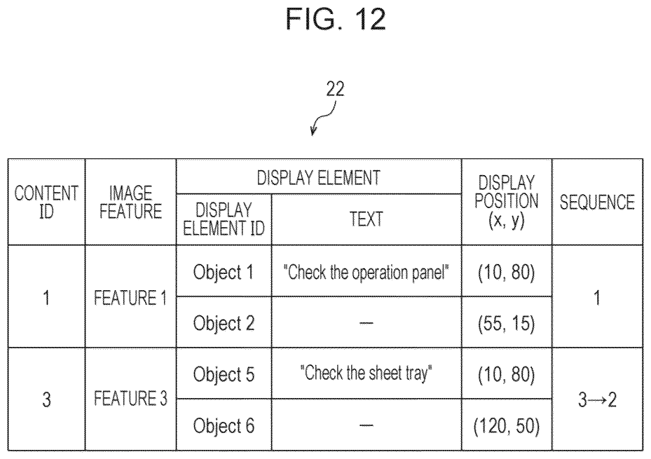

FIG. 12 illustrates an example of the modified content information 22.

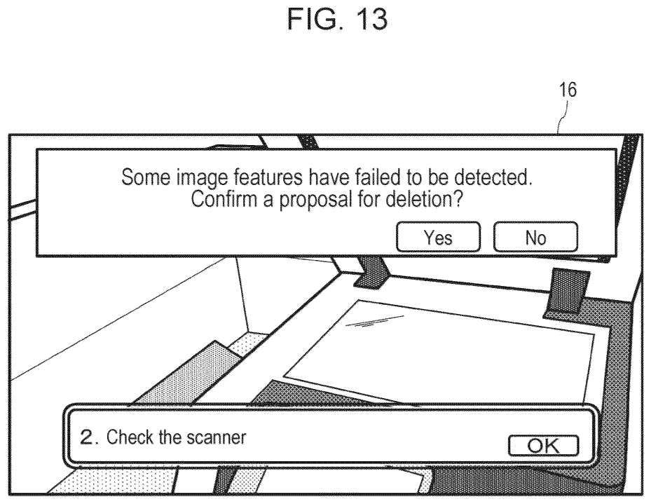

When the content-information modifying unit 30 determines that there is a deleted image feature, the display controller 26 may notify, to the modifier, information about the deleted image feature prior to deletion of the unit content for the deleted image feature. For example, as illustrated in FIG. 13, the display controller 26 may display, on the display 16, the display elements, which are associated with the deleted image feature (in this example, “feature 2”) in the content information 22. In addition, when, in the content information 22, each image feature is associated with a still image including the image feature, the display controller 26 may display, on the display 16, the still image associated with the deleted image feature.

The display controller 26 may display, on the display 16, a text such as “Some image features have failed to be detected.” as well as information about the deleted image feature. When a modifier presses “Yes” in response to the text, the content-information modifying unit 30 deletes, from the content information 22, the unit content for the deleted image feature in accordance with the instruction from the modifier.

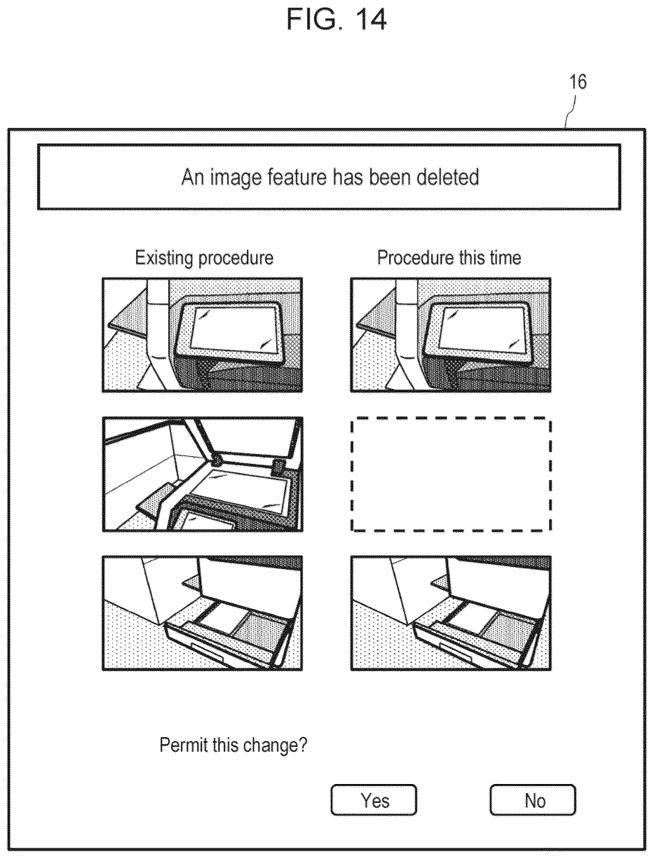

When, in the content information 22, each image feature is associated with a still image including the image feature, as illustrated in FIG. 13, the display controller 26 may display, on the display 16, a text such as “Some image features have failed to be detected. Confirm a proposal for deletion?” as well as information about the deleted image feature. When a modifier presses “Yes” in response to the text, as illustrated in FIG. 14, the display controller 26 may display, on the display 16, the still images, which correspond to the image features included in the content information 22, and the frame images, in which image features are detected from the target movie, prior to the content-information modifying unit 30 modifying the content information 22. When the modifier approves (for example, presses the “Yes” button) on the screen, the content-information modifying unit 30 deletes the unit content for the deleted image feature.

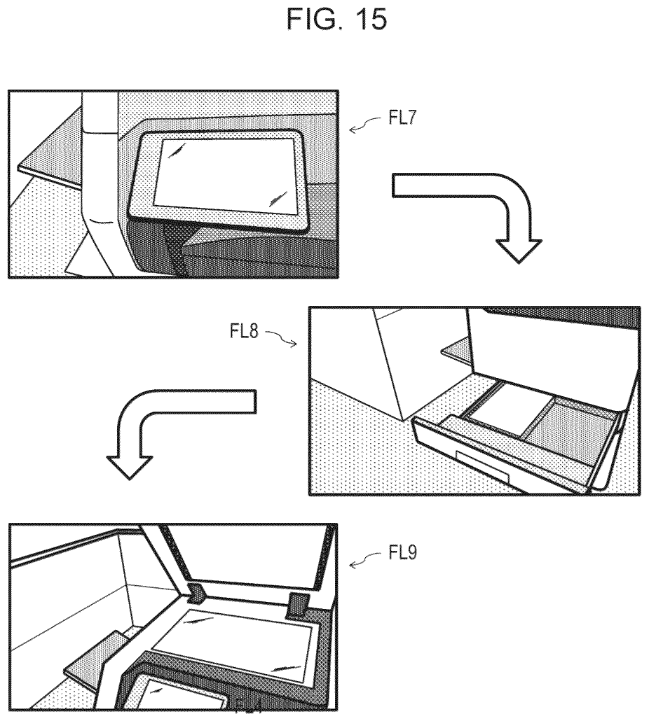

Lastly, referring to FIGS. 15 to 17, modification of sequence information of unit contents will be described. FIG. 15 is a diagram illustrating frame images FL7 to FL9 in which image features are detected in a target movie. The frame images FL7 to FL9 are arranged chronologically. That is, in the target movie, the frame image FL8 appears after the frame image FL7; the frame image FL9 appears after the frame image FL8.

In the example in FIG. 15, assume that an image feature of “feature 1” is detected from the frame image FL7 in the target movie; an image feature of “feature 3” is detected from the frame image FL8 in the target movie; an image feature of “feature 2” is detected from the frame image FL9 in the target movie.

The content-information modifying unit 30 compares the image features, which are detected from the target movie, with the image features, which are included in the content information 22. As described above, in the example in FIG. 15, the image features detected from the target movie are “feature 1”, “feature 3”, and “feature 2”. In contrast, the image features included in the content information 22 are “feature 1”, “feature 2”, and “feature 3”. That is, the image features detected from the target movie are the same as those included in the content information 22. However, the order of appearance, in the target movie, of the image features detected from the target movie is different from the order of appearance of the image features, which is indicated by the sequence information of the image features included in the content information 22. In this case, the content-information modifying unit 30 determines that there is a difference between the image features, which are detected from the target movie, and the image features, which are included in the content information 22.

In this case, the content-information modifying unit 30 modifies the sequence information, which is associated with the image features in the content information 22, so that the sequence information matches the order of appearance, in the target movie, of the image features detected from the target movie. For example, in this example, the sequence information associated with the image feature of “feature 2” is modified from “2” to “3”, and the sequence information associated with the image feature of “feature 3” is modified from “3” to “2”.

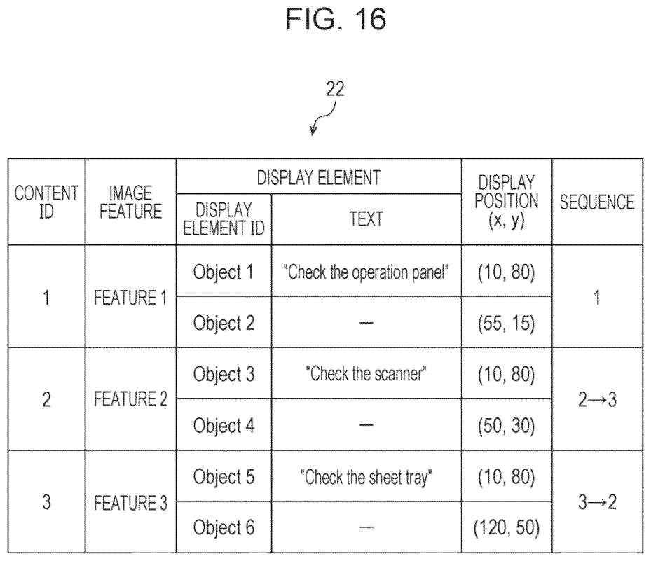

FIG. 16 indicates an example of the modified content information 22.

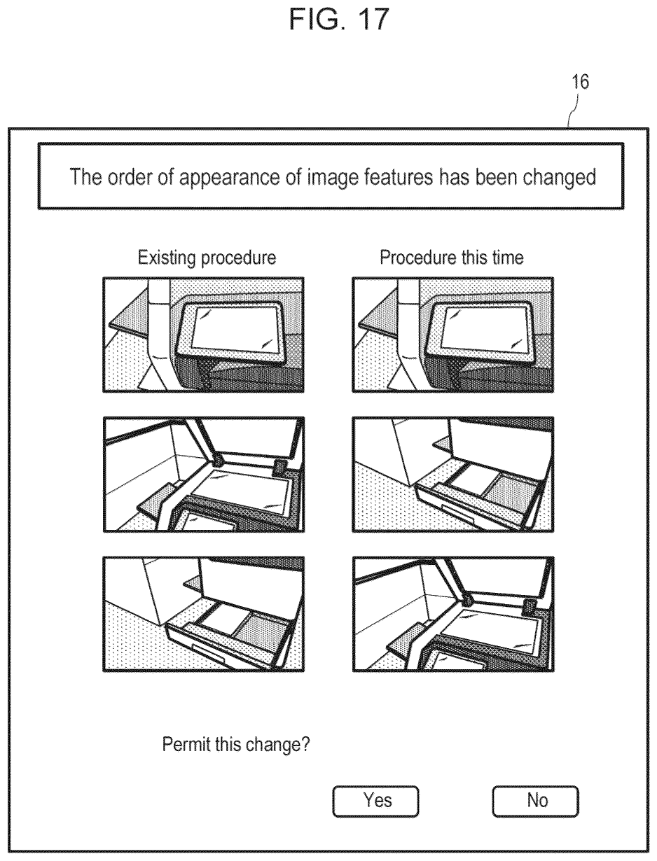

When, in the content information 22, each image feature is associated with a still image including the image feature and when the order of appearance, in a target movie, of the image features detected from the target movie is different from the order of appearance of the image features included in the content information 22, as illustrated in FIG. 17, the display controller 26 may display, on the display 16, the still images, which correspond to the image features included in the content information 22, in the order of the sequence information associated with the image features, prior to the content-information modifying unit 30 modifying the content information 22. At the same time, the display controller 26 may display, on the display 16, the frame images, in which the image features are detected from the target movie, in the order of appearance in the target movie. When a modifier approves (for example, presses the “Yes” button) on the screen, the content-information modifying unit 30 modifies the sequence information associated with the image features in the content information 22.

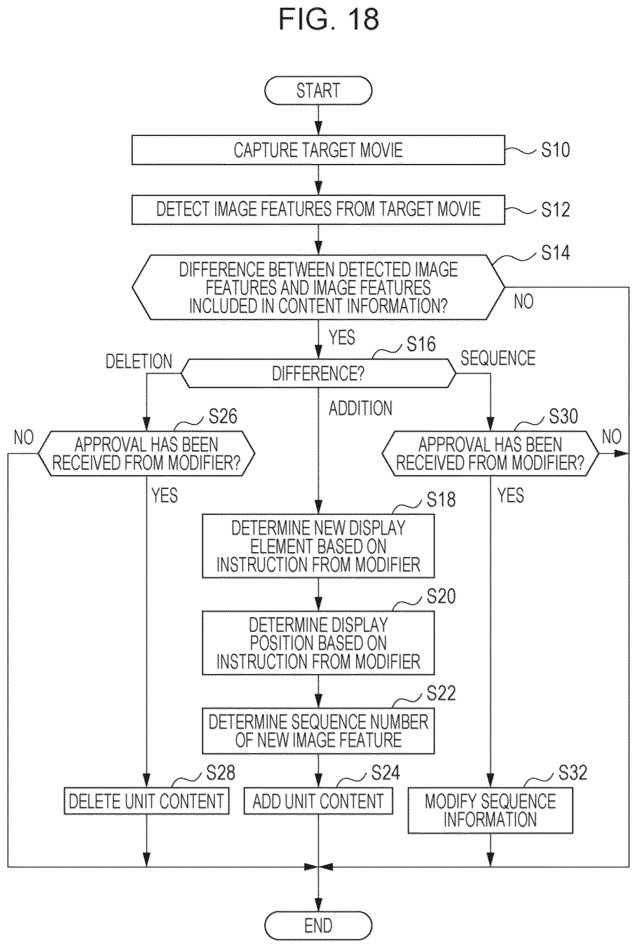

The overview of the information processing device 10 according to the present exemplary embodiment is described. The flow of the process of the information processing device 10 will be described below according to the flowchart in FIG. 18.

In step S10, the camera 14 captures a target movie.

In step S12, the image-feature detection unit 28 detects image features from the target movie.

In step S14, the content-information modifying unit 30 determines whether there is a difference between the image features, which are detected from the target movie in step S12, and the image features, which are included in the content information 22. If there is no difference, the process ends. If there is a difference, the process proceeds to step S16.

In step S16, the content-information modifying unit 30 determines the difference between the image features detected from the target movie and the image features included in the content information 22. If a new image feature, which is not included in the content information 22, has been detected, the difference indicates addition. In this case, the process proceeds to step S18.

In step S18, the content-information modifying unit 30 determines a new display element, which is to be associated with the new image feature, on the basis of an instruction from a modifier of the content information 22. For example, the content-information modifying unit 30 determines a text, which is included in the new display element, on the basis of the instruction from the modifier.

In step S20, the content-information modifying unit 30 determines the display position of the new display element on the basis of an instruction from the modifier of the content information 22.

In step S22, the content-information modifying unit 30 determines the sequence number of the new image feature on the basis of the order of appearance of the image features detected from the target movie.

In step S22, the content-information modifying unit 30 adds, to the content information 22, a unit content in which a new content ID, the new image feature, the display element ID of the new display element, the text of the new display element, the display position of the new display element, and the sequence information are associated with each other.

In step S16, if there is a deleted image feature which is included in the content information 22 and which is not detected from the target movie, the difference indicates deletion. In this case, the process proceeds to step S26.

In step S26, the content-information modifying unit 30 determines whether approval has been received from the modifier. If approval fails to be received from the modifier, the content-information modifying unit 30 does not modify the content information 22, and ends the process. If approval has been received from the modifier, the process proceeds to step S28.

In step S28, the content-information modifying unit 30 deletes, from the content information 22, the unit content for the deleted image feature.

In step S16, if the image features, which are detected from the target movie, are the same as those included in the content information 22 and if the order of appearance, in the target movie, of the image features detected from the target movie is different from the order of appearance of the image features, which is indicated by the sequence information of the image features included in the content information 22, the difference is in the sequence. In this case, the process proceeds to step S30.

In step S30, the content-information modifying unit 30 determines whether approval has been received from the modifier. If approval fails to be received from the modifier, the content-information modifying unit 30 does not modify the content information 22, and ends the process. If approval has been received from the modifier, the process proceeds to step S32.

In step S32, the content-information modifying unit 30 modifies the sequence information, which is associated with the image features in the content information 22, so that the sequence information matches the order of appearance, in the target movie, of the image features detected from the target movie.

The exemplary embodiment according to the present disclosure is described above. The present disclosure is not limited to the exemplary embodiment described above. Various changes may be made without departing from the gist of the present disclosure.

For example, in the present exemplary embodiment, the content information 22 is stored in the memory 20 of the information processing device 10. Alternatively, the content information 22 may be stored in a different apparatus (such as a server) which is capable of communicating with the information processing device 10 (in other words, which may be accessed by the processor 24).

In the present exemplary embodiment, the processor 24 of the information processing device 10 fulfills the functions of the image-feature detection unit 28 and the content-information modifying unit 30. Alternatively, a processor of a different apparatus, which is capable of communicating with the information processing device 10, may fulfill the functions.

For example, the processor 24, which serves as a first processor of the information processing device 10, may fulfill the functions of the display controller 26; a second processor of a first apparatus other than the information processing device 10 may fulfill the functions of the image-feature detection unit 28; a third processor of a second apparatus other than the information processing device 10 may fulfill the functions of the content-information modifying unit 30. In this case, the functions in the present disclosure are fulfilled by an information processing system including these apparatuses. The first apparatus and the second apparatus may be the same or may be different from each other. The second processor and the third processor may be the same or may be different from each other.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### APPENDIX

(((1)))

An information processing device comprising:
a processor configured to:
   be capable of accessing a memory storing content information in which a plurality of image features are each associated with a corresponding display element, the display element being displayed on a display unit when the image feature is detected from a movie displayed on the display unit;
   detect, from a target movie which is a target to be processed, a plurality of image features in accordance with a predetermined rule; and
   in response to a difference between the plurality of image features detected from the target movie and the plurality of image features included in the content information, modify the content information on a basis of the difference.
      (((2)))

The information processing device according to (((1))),
wherein the processor is configured to:
   in response to detection of a new image feature from the target movie, the new image feature being not included in the content information, add, to the content information, the new image feature in association with a new display element which is the display element newly determined.
      (((3)))

The information processing device according to (((2))),
wherein the processor is configured to:
   determine the new display element on a basis of an instruction from a modifier of the content information.
      (((4)))

The information processing device according to (((2))) or (((3))),
wherein the processor is configured to:
   determine a display position of the new display element on the display unit on a basis of an instruction from a modifier of the content information; and
   further associate, for addition to the content information, the display position with the new image feature and the new display element.
      (((5)))

The information processing device according to (((1))),
wherein the processor is configured to:
   when there is a deleted image feature that is an image feature which is included in the content information and which is not detected from the target movie, delete, from the content information, the deleted image feature and the display element associated with the deleted image feature.
      (((6)))

The information processing device according to (((5))),
wherein the processor is configured to:
   notify, to a modifier of the content information, information about the deleted image feature; and
   delete, from the content information, the deleted image feature and the display element associated with the deleted image feature, in accordance with an instruction from the modifier.
      (((7)))

The information processing device according to (((1))),
wherein, in the content information, each of the plurality of image features is further associated with a sequence number at which the image feature is to appear in a movie, and
wherein the processor is configured to:
   when the order of appearance, in the target movie, of the plurality of image features detected from the target movie is different from the order of appearance of the plurality of image features included in the content information, modify the sequence number associated with each image feature in the content information, the modified sequence numbers matching the order of appearance, in the target movie, of the plurality of image features detected from the target movie.
      (((8)))

The information processing device according to any one of (((1))) to (((7))),
wherein the processor is configured to:
   detect, in the target movie, an image feature of an object photographed continuously for a predetermined time or longer.
      (((9)))

The information processing device according to any one of (((1))) to (((8))),
wherein, in the content information, each of the plurality of image features is associated with a still image including the image feature, and
wherein the processor is configured to:
   display, on the display unit, a plurality of still images and a plurality of frame images prior to modification of the content information, the plurality of still images being included in the content information, the plurality of frame images being included in the target movie, the plurality of frame images being frame images in which corresponding image features are detected from the target movie.
      (((10)))

An information processing program causing a computer to execute a process, the computer being capable of accessing a memory storing content information in which a plurality of image features are each associated with a corresponding display element, the display element being displayed on a display unit when the image feature is detected from a movie displayed on the display unit, the process comprising:
detecting, from a target movie which is a target to be processed, a plurality of image features in accordance with a predetermined rule; and
in response to a difference between the plurality of image features detected from the target movie and the plurality of image features included in the content information, modifying the content information on a basis of the difference.
   (((11)))

An information processing system comprising:
one or more processors configured to:
   be capable of accessing a memory storing content information in which a plurality of image features are each associated with a corresponding display element, the display element being displayed on a display unit when the image feature is detected from a movie displayed on the display unit;
   detect, from a target movie which is a target to be processed, a plurality of image features in accordance with a predetermined rule; and
   in response to a difference between the plurality of image features detected from the target movie and the plurality of image features included in the content information, modify the content information on a basis of the difference.

What is claimed is:

1. An information processing device comprising:
a processor configured to:
be capable of accessing a memory storing content information in which a plurality of image features are each associated with a corresponding display element, the display element being displayed on a display unit when the image feature is detected from a movie displayed on the display unit;
detect, from a target movie which is a target to be processed, a plurality of image features in accordance with a predetermined rule; and
in response to a difference between the plurality of image features detected from the target movie and the plurality of image features included in the content information, modify the content information on a basis of the difference.

2. The information processing device according to claim 1,
wherein the processor is configured to:
in response to detection of a new image feature from the target movie, the new image feature being not included in the content information, add, to the content information, the new image feature in association with a new display element which is the display element newly determined.

3. The information processing device according to claim 2,
wherein the processor is configured to:
determine the new display element on a basis of an instruction from a modifier of the content information.

4. The information processing device according to claim 2,
wherein the processor is configured to:
determine a display position of the new display element on the display unit on a basis of an instruction from a modifier of the content information; and
further associate, for addition to the content information, the display position with the new image feature and the new display element.

5. The information processing device according to claim 3,
wherein the processor is configured to:
determine a display position of the new display element on the display unit on a basis of an instruction from the modifier of the content information; and
further associate, for addition to the content information, the display position with the new image feature and the new display element.

6. The information processing device according to claim 1,
wherein the processor is configured to:
when there is a deleted image feature that is an image feature which is included in the content information and which is not detected from the target movie, delete, from the content information, the deleted image feature and the display element associated with the deleted image feature.

7. The information processing device according to claim 6,
wherein the processor is configured to:
notify, to a modifier of the content information, information about the deleted image feature; and
delete, from the content information, the deleted image feature and the display element associated with the deleted image feature, in accordance with an instruction from the modifier.

8. The information processing device according to claim 1,
wherein, in the content information, each of the plurality of image features is further associated with a sequence number at which the image feature is to appear in a movie, and
wherein the processor is configured to:
when the order of appearance, in the target movie, of the plurality of image features detected from the target movie is different from the order of appearance of the plurality of image features included in the content information, modify the sequence number associated with each image feature in the content information, the modified sequence numbers matching the order of appearance, in the target movie, of the plurality of image features detected from the target movie.

9. The information processing device according to claim 1,
wherein the processor is configured to:
detect, in the target movie, an image feature of an object photographed continuously for a predetermined time or longer.

10. The information processing device according to claim 1,
wherein, in the content information, each of the plurality of image features is associated with a still image including the image feature, and
wherein the processor is configured to:
display, on the display unit, a plurality of still images and a plurality of frame images prior to modification of the content information, the plurality of still images being included in the content information, the plurality of frame images being included in the target movie, the plurality of frame images being frame images in which corresponding image features are detected from the target movie.

11. A non-transitory computer readable medium storing a program causing a computer to execute a process for information processing, the computer being capable of accessing a memory storing content information in which a plurality of image features are each associated with a corresponding display element, the display element being displayed on a display unit when the image feature is detected from a movie displayed on the display unit, the process comprising:
detecting, from a target movie which is a target to be processed, a plurality of image features in accordance with a predetermined rule; and
in response to a difference between the plurality of image features detected from the target movie and the plurality of image features included in the content information, modifying the content information on a basis of the difference.

12. An information processing method for a computer being capable of accessing a memory storing content information in which a plurality of image features are each associated with a corresponding display element, the display element being displayed on a display unit when the image feature is detected from a movie displayed on the display unit, the method comprising:
detecting, from a target movie which is a target to be processed, a plurality of image features in accordance with a predetermined rule; and
in response to a difference between the plurality of image features detected from the target movie and the plurality of image features included in the content information, modifying the content information on a basis of the difference.
